(19) United States
(12) Patent Application Publication
(10) Pub. No.: US 2021/0228429 A1
(43) Pub. Date: Jul. 29, 2021

(54) LUMBAR TRACTION APPARATUS

(71) Applicant: Enerfine Oy, Kokkola (FI)

(72) Inventors: Jarkko Ojala, Kokkola (FI); Kennet Törnroos, Kokkola (FI)

(21) Appl. No.: 17/149,287

(22) Filed: Jan. 14, 2021

(30) Foreign Application Priority Data
Jan. 28, 2020 (FI) 20207015

(51) Int. Cl. A61H 1/02

(52) U.S. Cl. CPC A61H 1/0229; A61H 2201/1652; A61H 2201/0149; A61H 2203/0431

(57) ABSTRACT

A lumbar traction arrangement, comprising movement means arranged to receive a sitting person and arranged to allow movement of the person, and traction means operatively coupled to the movement means causing variable vertical traction to the person's lumbar during movement provided by the movement means.

### CROSS-REFERENCE TO RELATED APPLICATION

This patent application claims the benefit of priority under 35 U.S.C. § 119(a)-(d) to Finnish Patent Application No.: FI20207015, filed on Jan. 28, 2020, which is incorporated herein by reference.

### TECHNICAL FIELD

This disclosure relates to a lumbar traction apparatus.

### BACKGROUND

One way to relieve back pain is to apply spinal traction, that is decompression therapy relieving pressure on the spine. Such treatment can be performed manually or mechanically. The known ways to perform lumbar traction treatment are, however, difficult and cumbersome to apply in practise. There is thus a need for a device that is easy to use and adapt to suit the subject person.

### SUMMARY

The present disclosure is directed to a lumbar traction arrangement for use on a person. The arrangement includes a support frame and a seat for supporting the person in a sitting position. The seat is mounted to the support frame so as to be movable relative to the support frame along a first linear path between first and second positions. Traction apparatus is disposed above the seat and includes support structures for positioning under the arms of the person so as to vertically support the person. Movement of the seat with the user thereon from the first position to the second position causes relative vertical movement between the seat and the support structures, thereby causing vertical traction to the person's lumbar.

### BRIEF DESCRIPTION OF THE DRAWINGS

The disclosure and some advantageous embodiments have been illustrated in the accompanying drawings, where

FIG. 1 shows an embodiment of a lumbar traction arrangement according to the disclosure;

FIG. 2 shows a side elevation of FIG. 1;

FIG. 3 shows the top elevation of FIG. 1;

FIG. 4 shows the bottom elevation of FIG. 1;

FIG. 5 shows a schematic side view of a traction arrangement according to other embodiments of the disclosure;

FIG. 6 shows a schematic end elevation view of an embodiment of the traction arrangement of FIG. 5 in which a pair of tracks are mounted to a ceiling and ropes are movably mounted to the tracks, respectively;

FIG. 7 shows a schematic end elevation view of an embodiment of the traction arrangement of FIG. 5 in which ropes are fixed to a pair of anchors secured to a ceiling, respectively;

FIG. 8 shows a schematic end elevation view of an embodiment of the traction arrangement of FIG. 5 in which a single track is mounted to a ceiling and ropes are movably mounted to the single track;

FIG. 9 shows a schematic end elevation view of an embodiment of the traction arrangement of FIG. 5 in which ropes are fixed to a single anchor secured to a ceiling; and

FIG. 10 shows a schematic side view of a traction arrangement according to still another embodiment of the disclosure in which a harness is connected to a track mounted to a ceiling.

### DETAILED DESCRIPTION OF ILLUSTRATIVE EMBODIMENTS

The embodiments relate to an arrangement or apparatus for enabling vertical traction to a person's lumbar.

In the embodiments, there is provided an apparatus, where a sitting person/user/patient is arranged to move in at least substantially horizontally, and the device is arranged to cause variable traction to the person's lumbar during the horizontal movement. In some embodiments, the variable traction refers to linearly changing traction. That is, the traction induced on the person, may increase linearly when the person moves from one end to the second end in the device. Respectively, when the person returns from the second end of the device to the first end, the traction may decrease linearly. This provides the significant advantage that the traction force is easily controllable by the person and therefore the device is safe to use.

In the embodiments, the person is arranged to sit when using the device. Thereby the person's back or spine is in vertical direction, and the traction is arranged to happen in vertical direction. This provides the significant advantage that the treatment effect can be achieved by using body mass/weight of the person, and no additional traction force generation devices are needed.

In the embodiments, the arrangement is configured to support the person from three support points when using the device. Two of the support levels reside in the device and one on the floor. One of the support points is configured to be against the backside of the person, and another support point at the underarms. The floor supports the person's feet. The support provided for the person from all points is dependent on the person's position in the device and dependent on the adjustments made by the person to the device.

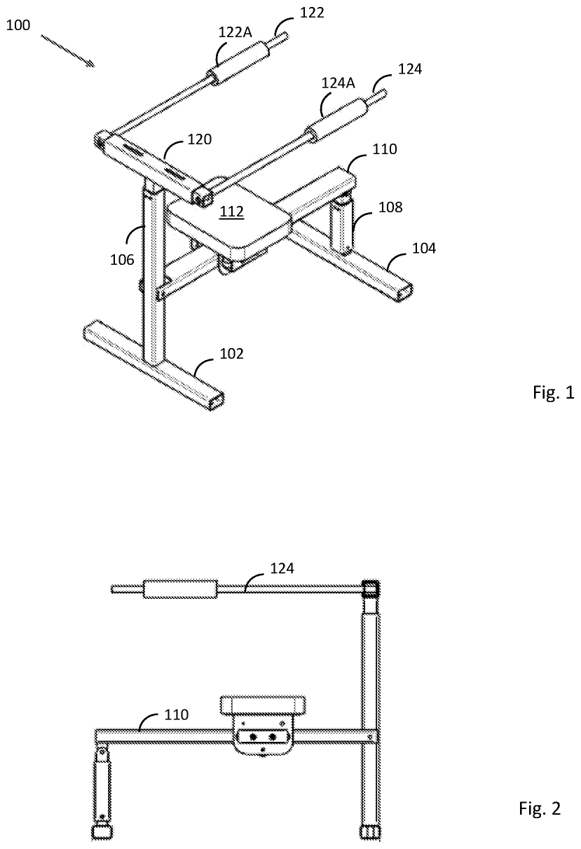

FIG. 1 illustrates one embodiment of a traction apparatus 100 according to the invention. The traction apparatus is intended to be arranged on a horizontal floor and thereby comprises horizontal feet or base 102, 104 arranged to be placed against the floor and thus to support the apparatus to stand on the floor.

Attached to the feet 102, 104, there are also provided vertical cross-bars 106, 108 for supporting other components of the apparatus with respect to the feet 102, 104.

The apparatus 100 comprises a seat rail 110 to which is mounted a seat for receiving a sitting person. The seat and the seat rail are operatively coupled in such a way that the seat is capable to move along the seat rail. One way to implement moving of the seat on the seat rail is to provide rotating rollers between the seat and the seat rail. As FIG. 1 shows, the seat rail is attached from a first end to the first vertical cross-bar 106, and from the second end to the second vertical cross-bar 108.

The height positions of the seat rail are preferably adjustable. The adjustability can be implemented by either providing several attachment points for the seat rail on the cross-bars or having the cross-bars themselves to be e.g. telescopic bars.

The adjustability of the seat rail serves for two purposes. On the other hand, the height adjustment provides persons of different sizes to use the apparatus. During use of the apparatus, the person sitting on the seat 112 may move the seat by stepping with feet on the floor. Thereby the taller person may desire to set the seat rail and seat higher from the floor than a short person.

The second purpose for the height adjustment(s) of the seat rail is that the seat rail may be set to an angle with respect to the horizontal floor level. For instance, the first end of the seat rail being attached to the first bar 106 may be set vertically higher than the second end at the bar 108. Preferably, the apparatus allows the angle of the seat rail to be set to an angle between 0 to 35 degrees, preferably between 5 to 25 degrees and even more preferably between 10 to 20 degrees. On the distance of 1 meter of the seat rail, the drop would thus be about 15 cm if the angle would be 15 degrees.

The apparatus may be further provided with a hand rail attachment bar 120 and two hand rails 122 and 124 attached to the hand rail attachment bar. The hand rail bar 120 may be attached to the first cross-bar 106 and is height-adjustable with respect to the first cross-bar. Height-adjustment may be provided by having the first cross-bar as a telescopic arrangement wherein the inner bar attached to the bar 120 can be adjusted with respect to the outer bar connecting to the base 102. The height adjustment of the bar 120 serves for the purpose of suiting the arrangement 100 for people of different sizes.

The hand rails 122 and 124 may be arranged to substantially the ends of the hand rail attachment bar 120 whereby the hand rails set to both sides of a person sitting on the seat 112 and using the apparatus. The hand rails 122, 124 may comprise respective sleeves 122A, 124A that can move on the rails. The sleeves that are adapted to be placed under-arm of the person may comprise soft material such as foam to feel convenient during use of the apparatus.

The hand rails may be angle adjustable similarly as the seat rail. The angle adjustment is arranged by providing angle adjustment members in the junction of the hand rail and the hand rail attachment bar.

When using the apparatus of FIG. 1, the user may first set the seat rail 110, and thereby the seat 112, and the hand rails 122, 124 to suitable height for him/herself. For traction treatment of the lumbar/back of the person, the user may set the seat rail 110 and the hand rails 122, 124 to a suitable angle with respect to each other. By forming an angle between the seat rail 110 and the hand rails 122, 124, the vertical distance between the hand rails 122, 124 and the seat 112 changes as the seat 112 moves between the first and second ends of the seat rail 110. In one exemplary embodiment, the user may set the hand rails 122, 124 to horizontal level, and the seat rail 110 to an inclined position. Such an inclined position may be such that the first end of the seat rail attaching to bar 106 may be set higher than the second end of the seat rail 110 attaching to the second bar. In this manner, the vertical distance between the hand rails 122, 124 and the seat 112 is smallest at the first end of the seat rail 110 and greatest at the second end of the seat rail 110. Thus, when a person sits on the seat 122, with the hand rails 122, 124 under their arms, and the seat 112 moves from first end of the seat rail to the second end of the seat rail, the person experiences traction in his/her lumbar/back potentially relieving symptoms therein.

Even though FIG. 1 illustrates the hand rails as straight bars, in another embodiment the hand-rails may be curved. In one embodiment, the curvature is implemented as a parabola-like curvature such that the highest point of the hand rail is in the middle of the hand rail. During use, the user would thus experience highest traction being in the middle of the seat rail where the hand rail would have its highest position. In such embodiment, the seat rail might be arranged to a horizontal arrangement.

In another embodiment, the hand rails could be curved but such that the highest point of the hand rail would be experienced at the end of the hand rail. In such embodiment, the traction would be increase rapidly from the beginning and more slowly after the start phase when moving along the hand rails from start to end.

The length of the arrangement and its components such as hand rails and seat rail in horizontal direction may be substantially between 1 meter and 2.5 meters, for instance.

FIG. 2 shows a side view of the apparatus of FIG. 1. In this view, the seat rail 110 and the hand rail 124 are both arranged substantially horizontal directions. However, at least one of the seat rail and the hand rails are adjustable by angle such their mutual angle can be set to be between 0 to 25 degrees, for instance. From FIG. 2 it can seen that the seat rail and hand rail have substantially equal length even though the seat rail may be slightly longer than the hand rail.

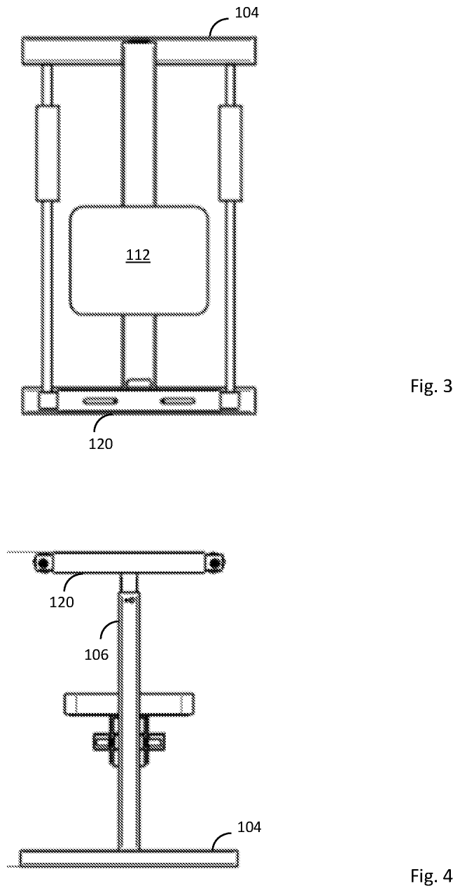

FIG. 3 shows a top elevation of the apparatus of FIG. 1. In some embodiments, the width of the apparatus defined by the hand rail attachment bar 120 and/or the base 104 is roughly between 60 cm to 100 cm. The distance between the hand rails from each other may be approximately 50 to 70 cm. In one embodiment, also the distance between the hand rails is adjustable such that the hand rails can be attached to different positions in the hand rail attachment bar taking into account different sized people.

FIG. 4 shows a view from the first end, that is from the end having the first vertical bar 106.

The device according to the invention is especially advantageous in avoiding complex means of attaching the person to a horizontal traction apparatus and being able to utilize the person's own weight in the traction treatment.

FIGS. 1 to 4 show one embodiment of the arrangement according to the disclosure.

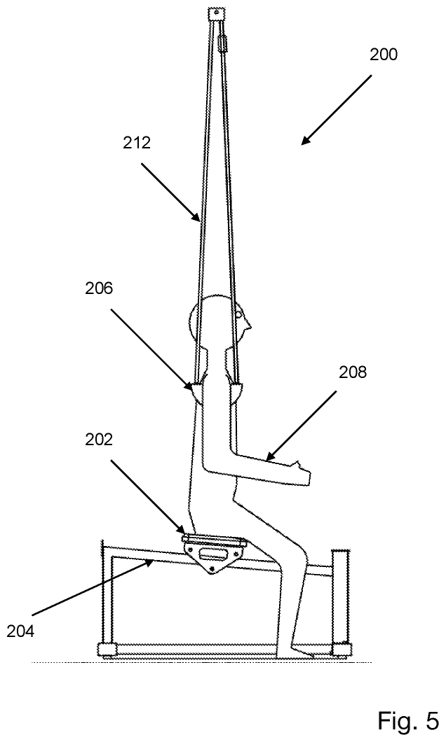

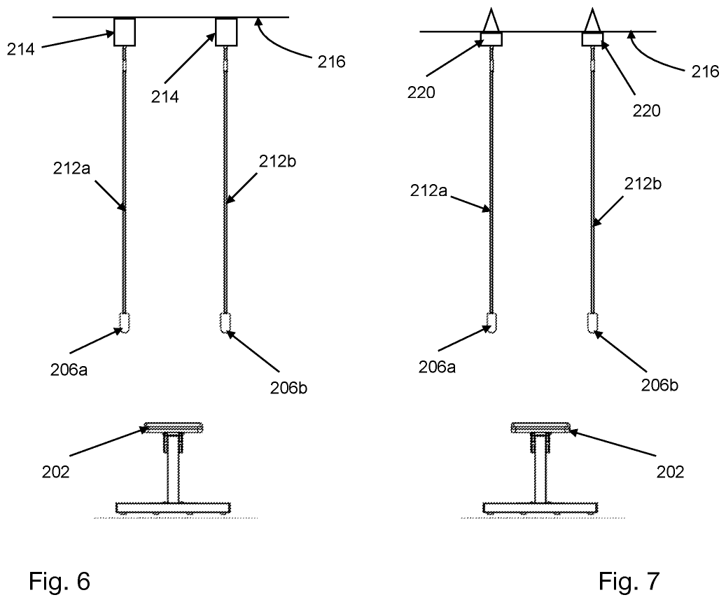

A traction apparatus 200 constructed in accordance with one or more other embodiments is shown in FIGS. 5-10. The traction apparatus 200 comprises a seat arrangement which may be similar than that shown in FIGS. 1 to 4. That is, there may be a seat 202 that is movable on a seat rail 204. The seat rail 204 may be arranged to a horizontal position or to a slight (10 to 20 degrees, for instance) angle with respect to the horizontal plane. Instead of the hand rails to be positioned underarm as in FIGS. 1 to 4, the apparatus 200 may be provided with, as traction means, supports 206 to be arranged under the arms of a person 208 or, in other variations, rings disposed around the arms or a band or harness 210 to be wound around the person's chest. In these embodiments, the supports/rings/band may be provided with one or more ropes 212 hanging from a roof or ceiling, for instance. The arrangement may be provided with “hand rails”, which in this embodiment could refer to rails 214 attached to the ceiling or roof of the room/building (as shown in FIG. 6).

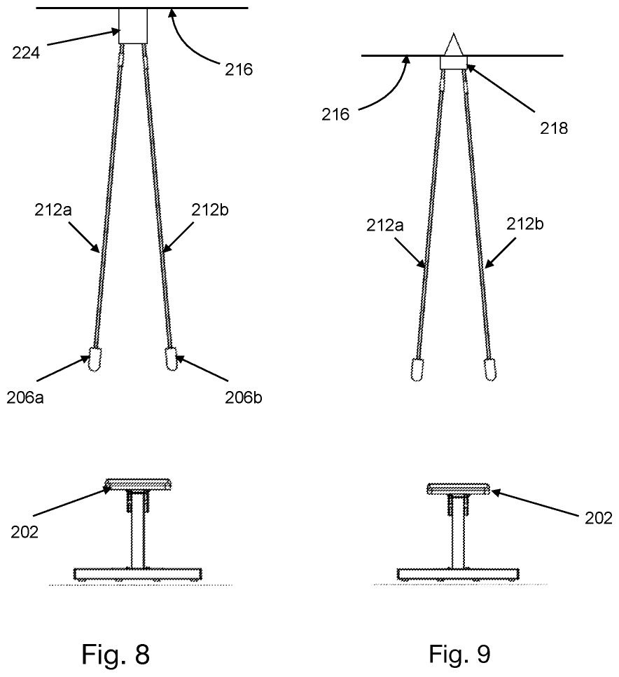

One or more ropes 212a are connected to the support 206a, while one or more ropes 212b are connected to the support 206b. For example, the support 206a may be connected to ends of a single rope 212a or to lower ends of a pair of ropes 212a and, similarly, the support 206b may be connected to ends of a single rope 212b or to lower ends of a pair of ropes 212b. The ropes 212 may be connected to a ceiling 216 or upper support structure so as to be fixed or movable. If the ropes 212 are fixed to the ceiling 216 or upper support structure, the ropes 212 are flexible and may all be fixed to a single fastening structure or anchor 218 immovably secured to the ceiling 216 or support structure, as shown in FIG. 9, or the ropes 212 may be fixed to separate fastening structures or anchors 220 immovably secured to the ceiling 216 or support structure, as shown in FIG. 7. Similarly, if the ropes 212 are movably connected to the ceiling 216 or upper support structure, the ropes 212 may all be fixed to a single carriage movably mounted to a single rail 224 secured to the ceiling 216 or support structure, as shown in FIG. 8, or the ropes 212 may be fixed to separate carriages movably mounted to a pair of rails 214 secured to the ceiling or support structure, as shown in FIG. 6.

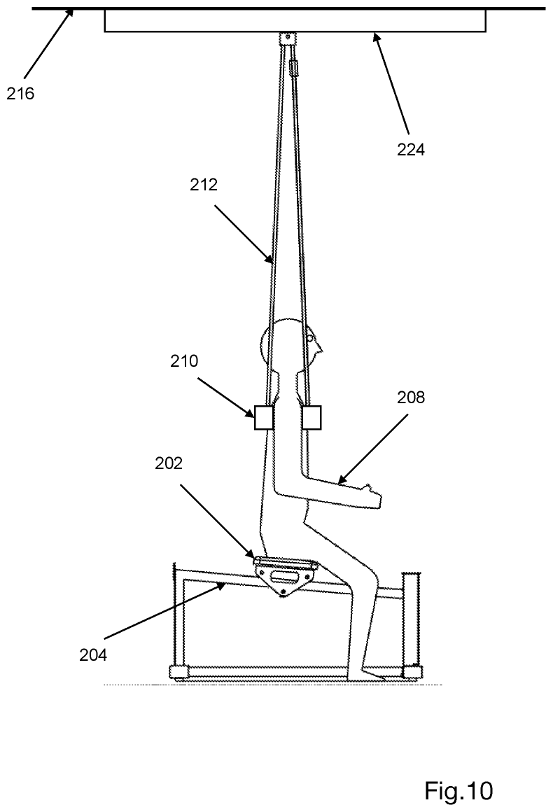

In those embodiments where a single band or harness 210 is used instead of a pair of supports 206, the harness 210 may be secured by one or more flexible ropes 212 to a single anchor 218 immovably secured to the ceiling or support structure. Alternately, the harness 210 may be secured by one or more ropes 212 to a single carriage movably mounted to a single rail 224 secured to the ceiling 216 or support structure. As shown in FIG. 10, two pairs of ropes 212 (one pair on each side of the person 208) may be used to secure the harness 210 to the anchor 218 or carriage.

Preferably the hand rails (e.g. rails 214) attached to the roof or ceiling are horizontally arranged, whereby the traction effectuating angle between the hand rail and seat rail is achieved by placing the seat rail to an angle with respect to the horizontal level. When the user moves on the seat rail, the supports/rings/harness hanging from the roof or ceiling and moving along the hand rails cause traction to person's lumbar, which traction has preferably linearly increasing/decreasing magnitude as the function of the person's position on the seat rail.

The first and second embodiments have in common the feature, that the person's upper support position being underarm or on the chest, moves along and in conjunction with the movement on the seat rail.

In an aspect, there is provided a lumbar traction arrangement, comprising movement means arranged to receive a sitting person and arranged to allow movement of the person; and traction means operatively coupled to the movement means causing variable vertical traction to the person's lumbar during movement provided by the movement means. That is, the person is received in the device, on a seat, in a sitting position. The seat is then movable and during that movement the traction means effectuates variable traction to the person's lumbar.

In an embodiment, the vertical traction is arranged to change linearly during movement provided by the movement means.

In an embodiment, in the movement means comprises a linear longitudinal direction, and the traction means comprises a linear longitudinal direction, and the linear longitudinal directions of the movement means and the traction means are arrangeable to an angle with respect to another. Preferably the movement means and traction means comprise bars or rails, which are linear and settable to an angle with respect to each other. In some embodiments, either the seat rail or the traction rail is arranged to a horizontal position and the other one is in angle with respect to the other one. However, it is also possible to set both rails/bars to an angle with respect to the horizontal plane.

In an embodiment the arrangement is configured to receive the person in a position where the person's spine is at least substantially in a vertical position. That is, during use the person is arranged to sit in the device, and the variable traction force is arranged to happen in at least substantially vertical direction whereby his/her spine is at least substantially vertical position.

In an embodiment, the arrangement is configured to support the person from the backside, and both underarms during use. That is, the person's backside is supported by the seat of the device, and the person's underarms are supported by hand rails or by rings hanging from a rail that can be arranged to a roof of the room, for instance.

In the embodiments, the movement means comprises a seat arranged to receive a sitting person, and a seat rail operatively connected to the seat allowing the seat can move along the seat rail. The seat may be arranged to move on the seat rail by means of rollers/rolls, for instance, arranged either to the seat and/or the rail.

In an embodiment, the traction means comprises hand rails arranged vertically higher than the seat rail, the hand rails being adapted to provide vertical support to the person when moving on the seat rail. Preferably the hand rails support the person under both arms. The hand rails may have sleeves that are movable along the hand rails to reduce friction and comfort for use.

In an embodiment, at least one of the seat rail and the hand rails are provided with angle adjustment means enabling setting the seat rail and hand rails to an angle with respect to each other such that when the person sitting on the seat moves along the seat rail, the hand rails arranged to an angle with respect to the seat rail cause variable traction to the lumbar of the person. The seat rail and the hand rails may be adjustable to an angle between 0 to 35 degrees, preferably an angle between 5 to 25 degrees, more preferably to an angle between 10 to 20 degrees, more preferably to approximately an angle being 15 degrees between each other.

In an embodiment, the seat rail and/or the hand rails are straight bars or rails.

In an embodiment, the hand rails are curved and the seat rail is straight whereby movement on the straight seat rail causes vertical traction to the upper body of the person. The highest point of the curved hand rails may be arranged to the middle of the hand rails or at one end of the hand rail.

In an embodiment the seat rail has a length between 50 cm to 200 cm, more preferably between 70 cm to 150 cm.

In an embodiment, the traction means comprises a second rail arranged above the person, and ropes arranged to move along the second rail, the traction means further comprising attachment means to attach to the person's upper body, preferably implemented as rings to be positioned around the person's arms or as a belt or harness to be arranged around the person's chest, and which second rail and the movement means are arrangeable to an angle with respect to each other such that variable traction is effectuated to the person moved by the movement means. That is, instead of having rails to be placed underarm of the user, the support to the traction force may be provided from above the person.

In an embodiment, the arrangement comprises a room, and the second rail is arranged to the roof or ceiling of the room.

In one embodiment, the traction means comprises a flexible rope and a fixed attachment point, such as an eyelet bolt fixed to a beam of a ceiling or roof. A first end of the rope is secured to the fixed attachment point and a second end of the rope is secured to attachment means, such as a band or harness that is attached or otherwise secured around the chest of a person. When the arrangement is used and the person moves by the movement means, the flexible rope is arranged to cause variable traction to the person's lumbar. That is, the attachment point may be horizontally above one end of the seat rail. When the user moves on the seat rail towards the second end, the traction force increases as the tension in the rope increases thereby causing traction to the person's lumbar.

It is evident that when the technology develops, the invention can be implemented in other ways. The invention and the embodiments are thus not limited to the preceding embodiments but can vary in the scope of the attached claims.

What is claimed is:

1. A lumbar traction arrangement for use on a person, comprising:
a support frame;
a seat for supporting the person in a sitting position, the seat being mounted to the support frame so as to be movable relative to the support frame along a first linear path between first and second positions;
traction apparatus disposed above the seat and including one or more support structures for positioning under the arms of the person so as to vertically support the person; and
wherein movement of the seat with the user thereon from the first position to the second position causes relative vertical movement between the seat and the one or more support structures, thereby causing vertical traction to the person's lumbar.

2. The lumbar traction arrangement of claim 1, wherein the vertical traction changes linearly as the seat moves from the first position to the second position.

3. The lumbar traction arrangement of claim 1, wherein the arrangement is configured to receive the person in a position where the person's spine is at least substantially in a vertical position.

4. The lumbar traction arrangement of claim 1, wherein when the seat moves from the first position to the second positon, the one or more support structures move or the person moves over the one or more support structures along a second linear path, and wherein the first and second linear paths are disposed at an angle with respect to each other.

5. The lumbar traction arrangement of claim 4, wherein the angle between the first and second linear paths is adjustable by changing the angle of the first linear path and/or the angle of the second linear path relative to the horizontal.

6. The lumbar traction arrangement of claim 5, wherein the one or more support structures of the traction apparatus comprise hand rails that are spaced apart and disposed above the seat for positioning under the arms of the person, respectively, the hand rails defining the second linear path over which the person travels as the seat with the person thereon moves from the first position to the second position.

7. The lumbar traction arrangement of claim 6, wherein the support frame comprises a seat rail connected between vertical bars, the seat rail supporting the seat and defining the first linear path, and wherein the seat rail has a first end that corresponds to the first position and a second end that corresponds to the second position.

8. The lumbar traction arrangement of claim 7, wherein the seat rail and the hand rails are straight, and wherein the first end of the seat rail and/or first ends of the hand rails are vertically movable to position the seat rail and/or the hand rails at an angle to the horizontal, such that the seat rail and the hand rails are disposed at an engle to each other, whereby when the person sitting on the seat moves along the seat rail, variable traction is applied to the lumbar of the person.

9. The lumbar traction arrangement of claim 8, wherein the angle between the seat rail and the hand rails is adjustable to be in a range of from 5 to 25 degrees.

10. The lumbar traction arrangement of claim 8, wherein a first one of the vertical bars is telescopically movable to vertically move the first end of the seat rail.

11. The lumbar traction arrangement of claim 1, wherein the one or more support structures of the traction apparatus comprise hand rails that are spaced apart and disposed above the seat, and wherein the support frame comprises a seat rail connected between vertical bars, the seat rail supporting the seat and defining the first linear path.

12. The lumbar traction arrangement of claim 11, further comprising cushioned sleeves disposed over the hand rails, respectively, the cushioned sleeves being movable over the hand rails, respectively.

13. The lumbar traction arrangement of claim 11, wherein the seat rail has a length between 50 cm and 200 cm.

14. The lumbar traction arrangement of claim 11, wherein the support frame further comprises a hand rail attachment bar connected to one of the vertical bars, and wherein the hand rails are connected in cantilever-fashion to the hand rail attachment bar and extend toward the other one of the vertical bars.

15. The lumbar traction arrangement of claim 11, wherein the hand rails are curved, whereby movement of the seat with the user thereon from the first position to the second position causes non-linear vertical traction to the person's lumbar.

16. The lumbar traction arrangement of claim 15, wherein the hand rails each have a parabola-like curvature such that the highest point of each hand rail is in the middle of the hand rail, whereby when the seat with the person thereon moves along the first path from the first position to the second position, the person experiences the highest traction in the middle of the first path.

17. The lumbar traction arrangement of claim 15, wherein each hand rail is curved such that the highest point of the hand rail is at the second position of the first path.

18. The lumbar traction arrangement of claim 1, wherein the traction apparatus further comprises at least one rail fixed above the seat and one or more ropes arranged to move along the at least one rail, the one or more ropes being secured to the one or more support structures.

19. The lumbar traction arrangement of claim 18, wherein the one or more support structures comprise a harness for positioning around the person's chest, or supports for positioning under the person's arms, respectively, wherein the at least one rail comprises a pair of rails secured to a ceiling of a room, and the one or more ropes comprise a pair of ropes having ends mounted to the rails, respectively.

20. The lumbar traction arrangement of claim 1, wherein the traction apparatus further comprises at least one fixture mounted above the seat, and a flexible rope having an end secured to the fixture and another end secured to a harness for attachment to the person.
